(19) United States
(12) Patent Application Publication
(10) Pub. No.: US 2009/0293866 A1
(43) Pub. Date: Dec. 3, 2009

(54) Solar Thermal Collector Insert

(75) Inventors: Stephen J. Horne, El Granada, CA (US); Mary Jane Hale, Sunnyvale, CA (US); Eric Prather, Santa Clara, CA (US); Peter Young, San Francisco, CA (US)

Correspondence Address: EDOUARD GARCIA;Attorney At Law, 1351 Cuernavaca Circulo, Mountain View, CA, 94040, US

(73) Assignee: SOLFOCUS, INC., Mountain View, CA (US)

(21) Appl. No.: 12/131,875

(22) Filed: Jun. 2, 2008

(51) Int. Cl. F24J 2/24; F24J 2/48; B23P 15/26

(52) U.S. Cl. 126/655; 126/677; 29/890.033

(57) ABSTRACT

A solar thermal energy collector with integrated flowpath is provided. The insert can be connected to a solar collector manifold for collecting solar energy. The insert with integrated flowpaths can be surrounded by an evacuated chamber. A fluid can be used to transfer the heat collected from the insert. The insert includes first and second flowpaths for conveying the heat transfer fluid. The fluid flowpath is continuous and integral to the insert. The fluid flowpath may be comprised of a group of chambers designed for efficient transfer of thermal energy. Methods of manufacture of inserts with continuous flowpaths are provided. These may include methods for the extrusion of inserts with integral flowpaths from a single piece of material.

### BACKGROUND

The present invention relates generally to the field of solar thermal energy. In particular, the present invention relates to an insert for a solar thermal energy collector with integrated flowpaths.

Solar thermal energy collectors convert the energy of the sun into a more usable or storable form. Sunlight provides energy in the form of electromagnetic radiation from the infrared (long) to the ultraviolet (short) wavelengths. The intensity of solar energy striking the earth's surface at any one time depends on weather conditions and the distance between the location of the earth's surface and the sun. Solar thermal collectors have been utilized for over 20 years. The designs have varied from flat plate, box, more commonly to parabolic troughs, dishes and full power towers. Though they have been commercially available for over 20 years, recent designs of evacuated tubes have become more efficient and less costly, allowing them to be commercially available as well as more widely utilized. Some designs contain heat removal inserts that are placed with the tubes that served the purpose of transferring the collected energy to a heat-transfer fluid and are used to transfer heat to a manifold located at the end of tubes or in connection with the inserts.

Solar thermal energy collectors can provide heat to hot water systems, swimming pools, a floor-coil heating circuit and the like. They may also be used for heating an industrial dryer, providing input energy for a cooling system or providing steam for industrial applications.

A solar thermal energy collector that stores heat energy is called a “batch” type system. Other types of solar thermal collectors do not store energy but instead use fluid circulation (usually water or an antifreeze solution) to transfer the heat for direct use or storage in an insulated reservoir. The direct radiation is usually captured using an insert with an absorbing surface which collects the radiation as heat and conducts it to the transfer fluid. Metal makes a good thermal insert, especially copper and aluminum. In high performance collectors, an absorbing surface is used in which the energy collector surface is coated with a material having properties of high-absorption and low emission. The warmed fluid leaving the collector is either directly stored, or else passes through a heat exchanger to warm another tank of water, or is used to heat, for example a building, directly.

Conventional designs are limited in their ability to transfer heat from the collector and high manufacturing expense. It is desirable to provide an efficient solar thermal energy collector that is inexpensive to manufacture.

### SUMMARY

A solar thermal energy collector with integrated flowpaths is provided. The collector comprises a receptacle capable of allowing a substantial amount of solar radiation to pass through it and an absorbing insert for absorbing the solar radiation. The absorbing insert is located inside the receptacle and includes an inlet port and an outlet port, a first fluid flowpath in separate fluid connection with the inlet port, and a second fluid flow path in separate fluid connection with the first fluid flowpath and the outlet port. The first fluid flow path and the second fluid flowpath are defined by, and are integral with, the absorbing insert.

In one embodiment of the invention, the first or second flowpaths may be comprised of a group of two or more chambers defined by a continuous, integral configuration with the absorbing insert. In another embodiment of this invention, the inlet port is comprised of a groove cut in the inner body of the absorbing insert sufficiently deep that it intersects with the first fluid flowpath, but not with the second fluid flowpath. In still another embodiment of the invention, the outlet port is comprised of a groove cut in the outer body of the absorbing insert sufficiently deep that it intersects with the second fluid flowpath, but not with the first fluid flowpath.

The solar thermal energy collector may comprise an insert with an endcap wherein the fluid connection between the first fluid flowpath and the second fluid flowpath of the insert is located primarily in the endcap. The solar thermal energy collector may have a heat transfer fluid, and the fluid may be mineral oil, water, kerosene or acetone. The solar thermal energy collector may comprise a receptacle selected from a group comprising a glass Dewar and a single glass wall tube.

The solar thermal energy absorbing insert of this invention may have an inlet port for transporting a heat transfer fluid and an outlet port for transporting the fluid located separate from the inlet port. The first fluid flowpath may be in separate fluid connection with the inlet port. The second fluid flowpath may be in separate fluid connection with the first fluid flowpath and the outlet port. The first and the second flowpath are defined by, and are integral with, the solar thermal energy absorbing insert.

The solar thermal energy absorbing insert may further comprise a selective surface coating located on a portion of the outer surface of the solar thermal energy insert to absorb more solar radiation. The selective surface coating may be aluminum nitride cermets.

In one embodiment of this invention, the fluid flowpath may be comprised of a group of chambers in fluid connection defined by, and integral with, the configuration of the solar thermal energy absorbing insert. The solar thermal energy absorbing insert of this invention may comprise an endcap in fluid connection between the first fluid flowpath and second fluid flowpath.

The method of this invention describes the manufacturing of a thermal energy absorbing insert. The steps may include obtaining a material with heat absorbing qualities and extruding the material into an absorbing insert. The configuration of the extruded insert may include an integral first fluid flowpath and an integral second fluid flowpath. The manufacturing method of this invention may also include directing the fluid in the first fluid flowpath in a first direction and the fluid in the second fluid flowpath in a second direction. The direction of fluid in the first flowpath may be substantially in the opposite direction of the second flowpath.

The method of manufacturing a thermal energy absorbing insert may include cutting a groove along an inner surface of the absorbing insert sufficiently deep to intersect with the first fluid flowpath while not intersecting with the second flowpath to provide an inlet. The manufacturing steps may also include cutting a groove along an outer surface of the absorbing insert sufficiently deep to intersect with the second fluid flowpath while not intersecting with the first flowpath to provide an outlet. The method of manufacturing a thermal energy absorbing insert further include applying a selective surface coating to a portion of the outer surface of the solar thermal energy insert to facilitate absorption of solar radiation.

In another embodiment of this invention, the method of manufacturing the thermal energy absorbing insert may further include attaching an endcap to support fluid flowing out of the first fluid flowpath and into the second fluid flowpath. In still another embodiment of this invention, the method of manufacturing a thermal energy absorbing insert may further include, attaching a frontcap to the absorbing insert in fluid connection with the first flowpath and second flowpath.

### BRIEF DESCRIPTION OF THE FIGURES

FIG. 1 depicts a cross-section of an embodiment of this invention showing an absorbing surface (10), a first flowpath comprised of two chambers (20), and a second flowpaths comprised of two chambers (30), an inner bore of the insert (40).

FIG. 2 depicts a cut away isometric view of one embodiment of the invention showing the insert surface (10) and first flowpath (20), second flowpath (30), inner bore (40), outer groove (50), inner groove (60), outer port groove (70), inner port groove (80).

FIGS. 3A, B depict radially symmetric cross sectional views of two embodiments of this invention showing the insert surface (10), outer chamber (20), inner chamber (30), inner bore (40), outer groove (50), inner groove (60), outlet port (70), inlet port (80), endcap (90), a mixing chamber (100), an inner and outer frontcap chamber (110, 120) for separate connection to a manifold via ducts (130, 140) in a frontcap (150).

FIG. 4 depicts examples of alternative geometries of the insert and chambers. FIG. 4A shows a single first flowpath and a second flowpath comprised of 6 chambers. FIG. 4B shows a single first flowpath and a second flowpath comprised of 2 curved chambers. FIG. 4C shows a first and second flowpath arranged in a perpendicular orientation. FIG. 4D shows first and second flowpaths comprised of multiple alternating chambers. FIG. 4E shows a cross section of an alternative insert shape with enclosed flowpaths. FIG. 4F shows a cross section of an alternative insert shape with a flattened integral flowpath. FIG. 4G shows a cross section of an alternative insert shape with two flattened flowpaths. FIG. 4H shows a cross section of an alternative insert shape with two circular flowpaths.

FIGS. 5A-5C depict additional embodiments of this invention. FIG. 5A shows a single first (250) and second flowpath (260) arranged in an opposite orientation. FIG. 5B shows a first (250) and second flowpath, (260) each divided into two chambers and arranged in an alternating orientation. FIG. 5C shows a similar configuration to FIG. 5B, but the shows the position of the first flowpath chambers (250) is closer to the center of the insert relative to the second flowpath chambers (260).

FIG. 6 shows an isometrics view of one embodiment of this invention.

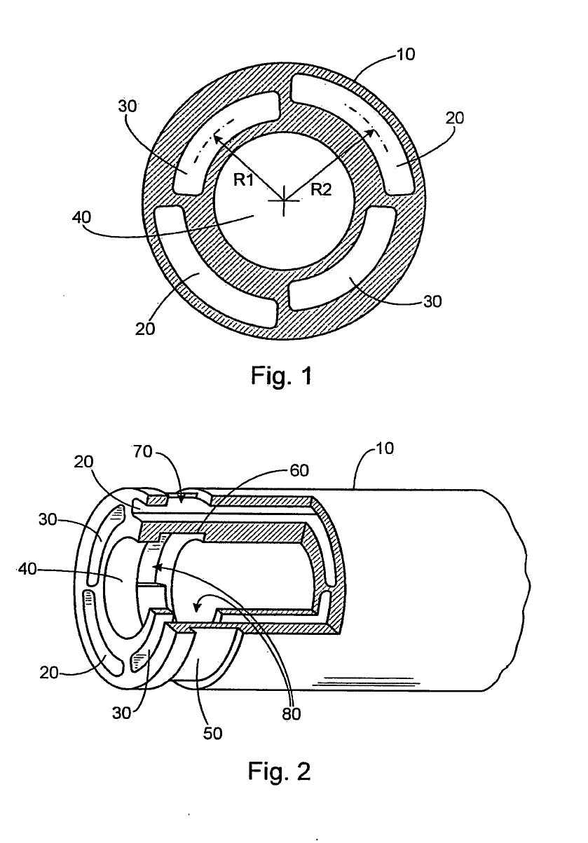

### DETAILED DESCRIPTION

It would be advantageous in the art to have a highly efficient solar collector which is simple to manufacture and provides superior energy transfer between an absorbing surface and a heat transfer fluid. Accordingly, the solar energy collector of this invention has many advantages. One advantage of the present invention is that it provides for an absorbing insert comprising one or more fluid flowpaths that are integral configurations of the insert. A first flowpath may direct a heat transfer fluid in one direction and the second fluid flowpath direct the fluid in substantially the opposite direction through the insert. The insert of this invention may be extruded from a single piece of material and is therefore efficient and cost-effective to manufacture. The insert of this invention may be comprised of an inner and outer wall. The insert of this invention may comprise a plurality of integral continuous flowpaths for a heat transfer fluid. Another advantage of this invention is that flowpaths that are continuous with the walls of the insert provide for superior transfer of solar energy from the absorbing surface to the transfer fluid by eliminating impediments to thermal transfer such as connecting welds, additional piping, and the like.

One aspect of this invention is that one or more fluid flowpaths are continuous and integral to the insert. In one embodiment of this invention, two fluid flowpaths are located between the inner and outer walls of the insert. In another embodiment of this invention, a first flowpath that is integral and continuous with the insert may be comprised of one or more fluidly connected chambers. In a second embodiment of this invention, a second flowpath that is integral and continuous with the insert may be comprised of one or more fluidly connected chambers. The plurality of chambers forming either or both flowpaths may be positioned internal to the absorbing surface in such a way to maximize thermal transfer from the absorbing surface to the transfer fluid. The shape of the flowpaths may be circular or ellipsoid or any other shape for efficiently conveying transfer fluid.

In one embodiment of this invention, the absorbing insert may be extruded from a single piece of material comprising an inner region and an outer region. The fluid flowpaths may be extruded as integral and continuous regions of the absorbing insert. The continuous flowpaths may be located on the inner surface of the absorbing insert or on the outer surface of the absorbing insert. The insert may be substantially tubular. The insert of this invention may be made from any extrudable material such as, but not limited to brass, copper or aluminum or any mixture thereof.

In one embodiment of this invention a portion of the outer surface of the absorbing insert may be coated with a solar selective surface coating. The selective surface coating provides for a high absorption of solar radiation and low emittance of thermal radiation. The surface coating can efficiently facilitate the conversion of solar energy to thermal energy. The solar selective surface may be deposited by reactive sputtering; thermal evaporation; ion assisted deposition; vacuum deposition; chemical vapor deposition; electron beam evaporation or any method known in the art. The general structure of these coatings may include, on top of the solar receiver substrate, a barrier layer, a solar coating and an antireflection capping layer. Numerous selective surfaces for solar applications may be used in the present invention. The coating can be optionally aluminum nitrate cermets or any other material known in the art that is used to facilitate the thermal absorption of solar thermal energy.

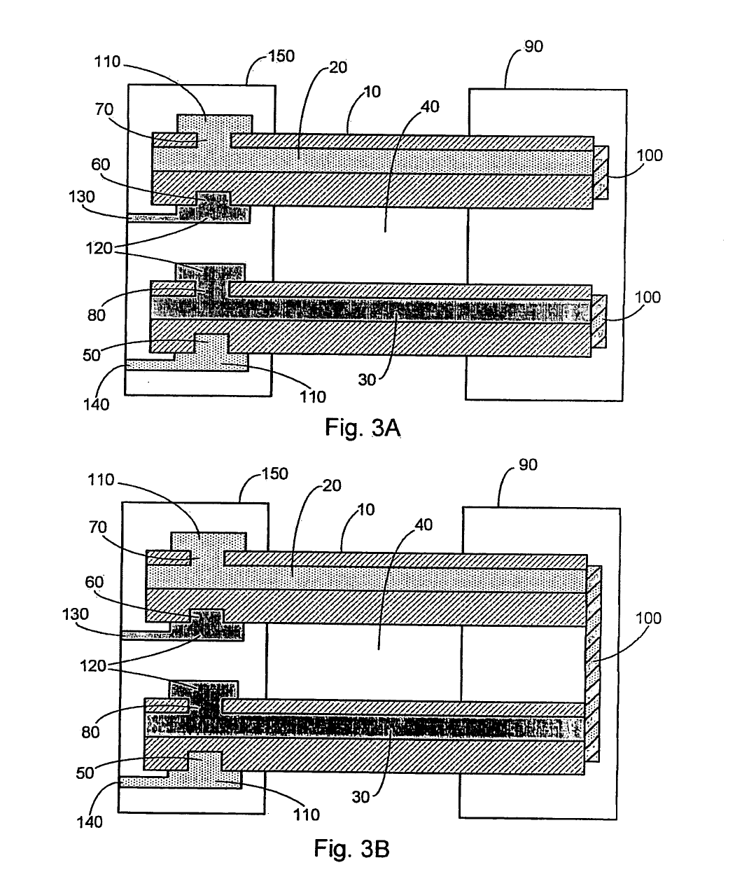

The fluid connection between the flowpaths may be integral to the insert. Alternatively the fluid connection between the flowpaths may occur through an endcap. The endcap may be integrated into the end of the absorbing insert and in fluid connection with two or more flowpaths. The endcap may comprise a chamber for mixing a heat transfer fluid. Two embodiments for a mixing chamber (100) in the endcap (90) are illustrated in FIG. 3A and FIG. 3B. In FIG. 3A the mixing chamber (100) is a radially symmetric circle shaped chamber in fluid connection with the two or more flowpaths. Mixing chambers shaped this way provide for simple manufacture. FIG. 3B shows an embodiment of this invention wherein the mixing chamber (100) is disk shaped. Mixing chambers of this and similar shapes provide for easy fluid connections for a wide variety of flowpath designs. The mixing chamber may be any shape that facilitates the flow of heat transfer fluid from the first flowpath to the second flowpath.

The solar thermal energy collector comprising the insert of this invention provides for an efficient process of heating fluid. The process includes conveying a heat transfer fluid through a first flowpath to a second flowpath. In one embodiment of the invention, the first flowpath may be integral and continuous with the absorbing insert. In another embodiment, the second flowpath may be integral and continuous with the absorbing insert. In yet another embodiment of this invention, thermal energy from the absorbing surface is efficiently transferred to the heat transfer fluid by thermal contact of the heat transfer fluid in the fluid flowpaths with the interior wall of the absorbing insert. The wall of the absorbing surface may be integral with the walls of the first and second flowpaths. The transfer of thermal energy is therefore, not impeded by connecting welds or secondary conduits, pipes or the like.

The solar energy insert of this invention can be adapted to a variety of solar thermal energy collectors. Solar thermal energy collectors can comprise an inner glass or metal insert through which heat exchange fluid is passed, and an outer transparent tube enveloping at least a portion of the length of the inner tube. In some cases the space between the outer transparent tube and the insert is evacuated. In one embodiment of this invention, a metal/glass seal is used to maintain a vacuum between the insert and an outer glass tube. In another embodiment, the tubes are cylindrical borosilicate glass bottles with a closed end. Alternatively, the outer glass tube can have a double wall configuration such as a Dewar wherein the space between outer glass walls is evacuated. In other embodiments, various types of commercially available outer tubes can be used.

The insert of the present invention provides for an improved and efficient process of heating fluid. This process includes conveying a heat transfer fluid through the integrated flowpaths of the insert. The transfer fluid may be any desired heat retaining fluid such as, but not limited to, water, oil, antifreeze, acetone, kerosene, or any combination thereof. The transfer fluid may be mineral oil. Thus, the transfer fluid may be in direct contact with a portion of the integral flowpath of the insert.

In one embodiment of the invention shown in FIG. 3, the insert is further comprised of an inlet port (80). The inlet port allows for the introduction of fluid into the insert. The inlet port may be comprised of a groove (60) bored into the interior of the insert shown in FIG. 2 such that it intersects with the first flowpath (30) but not the second flowpath (20). The groove may be cut with a lathe or any other groove cutting tool. In another embodiment of the invention, the insert is further comprised of an outlets port (70). The outlet port shown in FIG. 3 allows for the removal of fluid from the insert. The outlet port may be comprised of a groove (50) shown in FIG. 2 bored into the exterior of the insert such that it intersects with the second flowpath (20) but not the first flowpath (30). Groove (50) may be cut with a lathe or any other groove cutting tool.

Solar thermal collectors typically include a solar energy collecting insert, an insulating tube, and a manifold. In one embodiment shown in FIG. 3, the insert is coupled to a frontcap (150) in separate fluid connection with the inlet and outlet ports (70, 80). In yet another embodiment of this invention, the frontcap provides for a fluid communication with a manifold via ducts (140, 130). In yet another embodiment of the invention, the frontcap is integral to the manifold. The solar collector manifolds may be any of those known in the art, and they may be included in a panel with a clear plastic or glass cover. In one embodiment, the insert is coupled directly to a manifold, and the manifold is coupled to a pump that circulates the fluid through the manifold, the first flowpath and the second flowpath. The manifold may be coupled to the insert with a seal such as a glass-to-metal or a metal-to-metal seal. The manifold may include a tube-in-tube configuration. The manifold may be coupled to additional tubes.

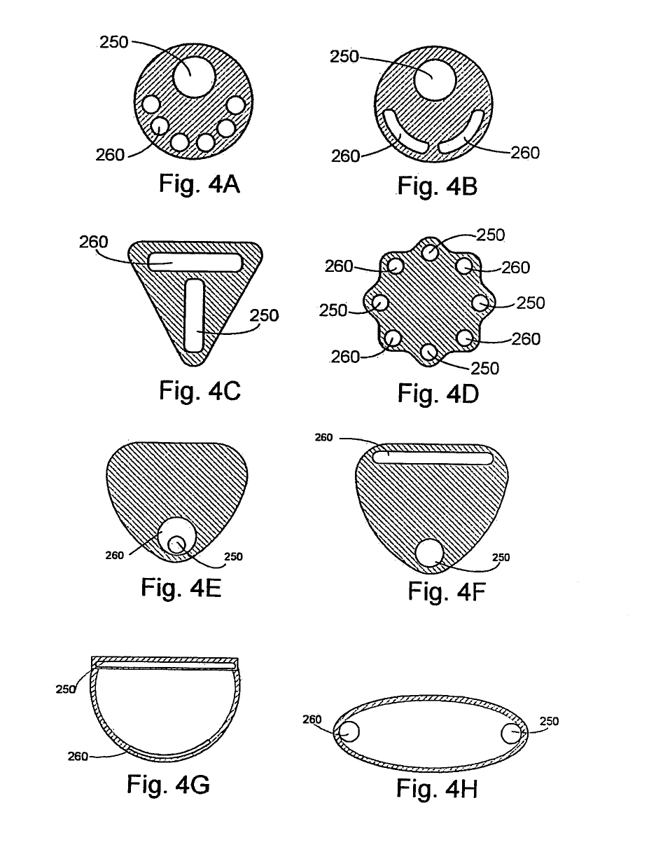

It can be seen in FIGS. 4A-4D that by using extrusion as a method of fabricating the insert of this invention, many configurations of insert can be generated. FIG. 4A illustrates one embodiments of this invention whereby the insert is comprised of a single first flowpath (250) and a second flowpath comprised of six chambers (260). In another embodiment of this invention shown in FIG. 4B, the insert may be comprised of a single first flowpath (250) and a second flowpath comprised of two chambers (260) shaped to maximize contact with the outer surface of the insert. Yet another embodiment of this invention is shown in FIG. 4C where the flowpaths (250, 260) are oriented in a perpendicular fashion. This arrangement provides for alternative optical designs directing solar radiation to the insert. In still another embodiment of this invention shown in FIG. 4D, multiple chambers for both the first (250) and second (260) flowpaths are envisioned and distributed around the outer region of the insert of this invention. These embodiments provide for easy extrusion while maximizing thermal contact of the flowpaths with the outer surface of the insert.

The surface of the insert of the present invention may likewise be of any shape. In one embodiment the shape of the insert is optimized to receive maximum normalized irradiation throughout the day. In still another embodiment, the solar energy insert comprises a flat surface in order to receive maximum solar irradiation at an angle normal to the suns rays. In another embodiment of the invention, the solar thermal energy collector comprises a reflector shaped to maximize solar radiation received at an angle normal to the surface of the insert. FIGS. 4E and 4F show embodiments of this invention wherein the solar irradiation may strike the flat surface of the insert of this invention at an angle that is substantially normal to the angle of the sun's rays. FIGS. 4G and H show embodiments of this invention wherein the insert shape may enable a higher fraction of the non-reflected solar radiation to strike the surface of the insert at an angle substantially closer to normal than other insert shapes.

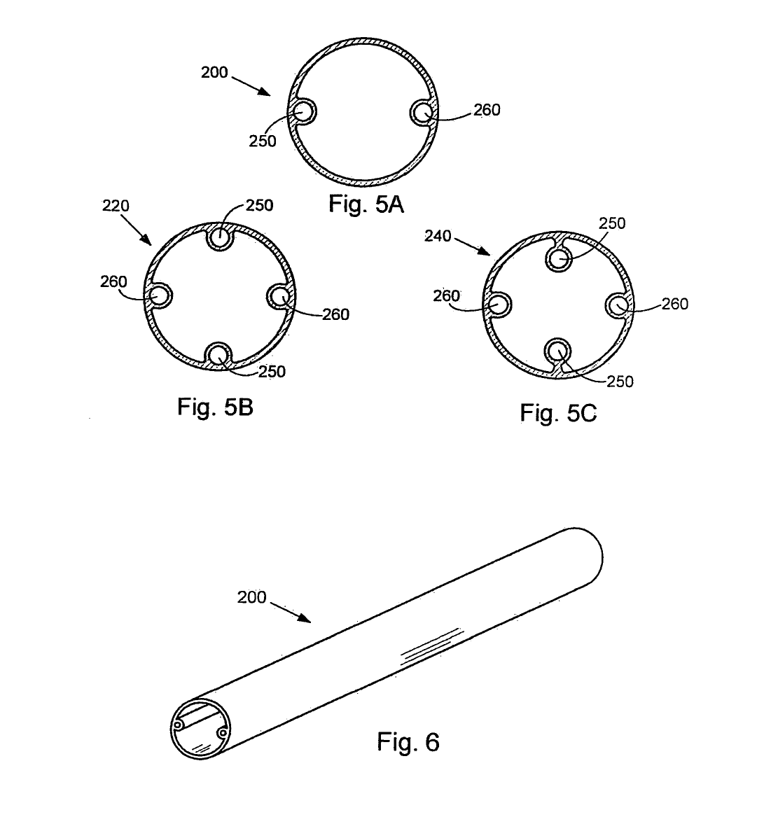

Additional embodiments of this invention can be seen in FIGS. 5A-5C. In one embodiment the insert is comprised of a single first flowpath (250) and a single second flowpath (260) positioned on opposite sides of the insert. FIG. 6 shows an isometric view of an insert with this flowpath arrangement. FIGS. 5B and 5C show embodiments wherein the first and second flowpaths are each comprised of a set of two chambers in an alternating arrangement. These embodiments accommodate an easily extruded, thin walled insert that maximizes thermal contact of the first and second flowpaths with the surface of the insert.

In one embodiment of this invention, a method is provided for the manufacture of solar thermal energy inserts. The method may comprise extruding a single piece of material, e.g., copper, aluminum, brass or a mixture of these metals. The materials to be extruded may also include tin, aluminum, copper, zirconium, titanium, molybdenum, beryllium, vanadium, niobium, and steel. In this embodiment, the extrusion provides an economical method of manufacture by producing the heat absorbing surface and integral flow paths for the heat exchange fluid in a single step. This may provide for a reduced bill of materials and a shorter manufacturing time. Extrusion may be continuous, producing indefinitely long material that may be cut to any length. Extrusion may be semi-continuous (producing many separate pieces). Extrusions may be done while the material is hot or cold. The method of this invention also provides for a die for the extrusion of a solar thermal energy insert wherein the heat absorbing surface and the flowpaths for the heat exchange fluid are formed in a single step and with a single piece of material.

Although embodiments of the invention have been discussed primarily with respect to specific embodiments thereof, other variations are possible. For example, while the invention has been described with respect to a simple solar, thermal collector insert, a more complex insert with special flow paths and configurations may also be used. External reflectors may be utilized to direct solar energy to the collector insert. For example, a reflector comprised of one or two or more pieces of reflective material may be used. Metal pieces may be replaced by sufficiently tolerant plastic, polymer pieces or the like. Steps can be added to, taken from or modified from the steps in this specification without deviating from the scope of the invention. The invention may be practiced in numerous applications, including commercial and residential.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed is:

1. A solar thermal energy collector for heating a fluid with solar radiation, comprising:
a receptacle capable of allowing a substantial amount of said solar radiation to pass through it;
an absorbing insert for absorbing said solar radiation, said absorbing insert being located inside said receptacle and including an inlet port and an outlet port;
a first fluid flowpath in separate fluid connection with said inlet port; and
a second fluid flow path in separate fluid connection with said first fluid flowpath and said outlet port;
wherein said first fluid flow path and said second fluid flow path are defined by and are integral with said absorbing insert.

2. The solar thermal energy collector of claim 1, wherein said first fluid flowpath is comprised of a first group of two or more chambers defined by a configuration of said absorbing insert.

3. The solar thermal energy collector of claim 1, wherein said second fluid flowpath is comprised of a second group of two or more chambers defined by a configuration of said absorbing insert.

4. The solar thermal energy collector of claim 1,
wherein said absorbing insert includes an inner body; and
wherein said inlet port is comprised of a groove cut in said inner body of said absorbing insert sufficiently deep that it intersects with said first fluid flowpath, but not with said, second fluid flowpath.

5. The solar thermal energy collector of claim 1,
wherein said absorbing insert includes an outer body; and
wherein said outlet port is comprised of a groove cut in said outer body of said absorbing insert sufficiently deep that it intersects with said second fluid flowpath, but not with said first fluid flowpath.

6. The solar thermal energy collector of claim 1, further comprising an endcap wherein a fluid connection between said first fluid flowpath and said second fluid flowpath is located primarily in said endcap.

7. The solar thermal energy collector of claim 1, wherein said fluid is selected from a group comprising mineral oil, water, kerosene and acetone.

8. The solar thermal energy collector of claim 1, wherein said receptacle is selected from a group comprising a glass Dewar and a single glass wall tube.

9. A solar thermal energy absorbing insert for absorbing solar radiation in a solar thermal energy collector and heating a fluid, comprising:
an inlet port for transporting said fluid;
an outlet port for transporting said fluid located separate from said inlet port;
a first fluid flowpath in separate fluid connection with said inlet port; and
a second fluid flowpath in separate fluid connection with said first fluid flowpath and said outlet port;
wherein said first flowpath and said second flowpath are defined by and are integral with said solar thermal energy absorbing insert.

10. The solar thermal energy absorbing insert of claim 9, further comprising a selective surface coating located on a portion of an outer surface of said solar thermal energy insert to absorb more solar radiation.

11. The solar thermal energy absorbing insert of claim 10, wherein said selective surface coating is aluminum nitride cermets.

12. The solar thermal energy absorbing insert of claim 9, wherein said first fluid flowpath is comprised of a first group of chambers in fluid connection defined by a configuration of said solar thermal energy absorbing insert.

13. The solar thermal, energy absorbing insert of claim 9, wherein said second fluid flowpath is comprised of a second group of chambers in fluid connection defined by a configuration of said solar thermal energy absorbing insert.

14. The solar thermal energy absorbing insert of claim 9, further comprising an endcap wherein a fluid connection between said first fluid flowpath and said second fluid flowpath is located primarily in said endcap.

15. A method of manufacturing a thermal energy absorbing insert, comprising the steps of:
obtaining a metal material with heat absorbing qualities; and
extruding said metal material into an absorbing insert configuration defining an integral first fluid flowpath and an integral second fluid flowpath;
wherein said integral first fluid flowpath is in a first direction and said integral second fluid flowpath is in a second direction; and
wherein said first direction is substantially in the opposite direction of said second direction.

16. The method of manufacturing a thermal energy absorbing insert of claim 15, further comprising the steps of:
cutting a groove along an inner surface of said absorbing insert sufficiently deep to intersect with said first fluid flowpath while not intersecting with said second flowpath to provide an inlet; and
cutting a groove along an outer surface of said absorbing inlet sufficiently deep to intersect with said second fluid flowpath while not intersecting with said first flowpath to provide an outlet.

17. The method of manufacturing a thermal energy absorbing insert of claim 15, further comprising the step of:
applying a selective surface coating to a portion of an outer surface of said solar thermal energy insert to facilitate absorption of solar radiation.

18. The method of manufacturing a thermal energy absorbing insert of claim 15, further comprising the step of:
attaching an endcap to support fluid flowing out of said first fluid flowpath and into said second fluid flowpath.

19. The method of manufacturing a thermal energy absorbing insert of claim 15, further comprising the step of:
attaching a frontcap to said absorbing insert in fluid connection with said first flowpath and said second flowpath.
